(19) United States
(12) Patent Application Publication
(10) Pub. No.: US 2012/0188608 A1
(43) Pub. Date: Jul. 26, 2012

(54) PRINT PROCESSING APPARATUS, CONTROL METHOD THEREOF, AND STORAGE MEDIUM STORING PRINT PROCESSING PROGRAM

(75) Inventor: Tadanori Nakatsuka, Kawasaki-shi (JP)

(73) Assignee: CANON KABUSHIKI KAISHA, Tokyo (JP)

(21) Appl. No.: 13/349,847

(22) Filed: Jan. 13, 2012

(30) Foreign Application Priority Data
Jan. 20, 2011 (JP) 2011-009671

(51) Int. Cl. G06K 15/02

(52) U.S. Cl. 358/1.18

(57) ABSTRACT

A print processing apparatus includes a margin reduction processing unit that saves printed papers by changing the positions of objects such as texts or drawings configuring document data in a predetermined layout direction. The margin detection unit specifies the distances of the margin portions between objects adjacent in the layout direction. The margin reduction effect prediction unit sums the distances of the margin portions, and multiplies the percentage of the summation result relative to the number of pages processed by the number of pages for the entire document to thereby calculate reduction prediction information about printed papers when performing margin reduction print processing. The prediction display unit displays the reduction prediction information about printed papers prior to margin reduction print execution.

### BACKGROUND OF THE INVENTION

1. Field of the Invention

The present invention relates to a margin reduction print processing technology that changes the layout of objects in a document for printout so as to allow saving paper.

2. Description of the Related Art

A technique (N-UP processing or the like) for printing a plurality of pages on a single sheet of paper is known. As a process for prompting a user to save paper, a printer driver that provides a warning for prompting the user to save paper when a paper saving print setting is not made is used. Japanese Patent Laid-Open No. 2004-318694 discloses a printing device that displays a message for prompting a user to save paper when a user executes printing on a plurality of pages using a default setting in spite of the fact that the printing device has a paper saving function.

However, in the system disclosed in Japanese Patent Laid-Open No. 2004-318694, warning is provided only upon print execution. For example, a user cannot readily confirm the number of printed papers in the middle of editing. Also, a user may not be able to determine whether or not margin reduction print processing is effective. For example, even if a print processing time is prolonged but the number of papers to be saved is many, a user may not be able to determine whether or not margin reduction print processing is expedient for execution. Additionally, when even one paper saving method is set in the printing device, the printing device does not provide warning. For example, even in the case where a plurality of paper saving methods is available and the number of papers to be reduced by a current print setting may be further reduced by another print setting, a user has no means for knowing such method. Furthermore, even when a user does not wish to save paper, the operational efficiency may undesirably be decreased if a warning pops up every time during printing.

### SUMMARY OF THE INVENTION

Accordingly, the present invention provides a print processing apparatus that predicts the effects of margin reduction print processing prior to print execution and presents the predicted effects to a user, a control method thereof, and a storage medium storing a print processing program.

According to an aspect of the present invention, a print processing apparatus that performs print processing for reducing the number of printed papers to be used by changing the position of objects configuring document data in a predetermined layout direction is provided that includes a margin detection unit configured to specify a margin portion between the objects adjacent in the layout direction; a prediction unit configured to calculate reduction prediction information when the print processing is performed based on the margin portion specified by the margin detection unit; and a display unit configured to display the reduction prediction information calculated by the prediction unit prior to print execution.

According to the present invention, the predicted effects of margin reduction print processing may be provided to a user prior to print execution.

Further features of the present invention will become apparent from the following description of exemplary embodiments with reference to the attached drawings.

### BRIEF DESCRIPTION OF THE DRAWINGS

FIG. 1 is a block diagram illustrating the hardware configuration of a margin reduction print processing apparatus according to an embodiment of the present invention.

FIG. 2 is a flowchart illustrating margin reduction print processing.

FIG. 3 is a flowchart illustrating an example of margin detection processing between objects in order to explain a first embodiment of the present invention in conjunction with FIGS. 4 to 8.

FIG. 4 is a diagram illustrating margin detection processing between objects.

FIG. 5 is a flowchart illustrating an example of prediction processing for the number of printed papers to be reduced.

FIG. 6 shows an exemplary illustration of the number of printed papers to be reduced.

FIG. 7 is a flowchart illustrating an example of display processing for the number of printed papers to be reduced.

FIG. 8 is a flowchart illustrating an example of margin reduction print processing.

FIG. 9 is a flowchart illustrating an example of margin detection processing between objects in order to explain a second embodiment of the present invention in conjunction with FIG. 10.

FIG. 10 is a diagram illustrating margin detection processing between objects.

FIG. 11 shows an exemplary illustration of the number of printed papers to be reduced according to a third embodiment of the present invention.

### DESCRIPTION OF THE EMBODIMENTS

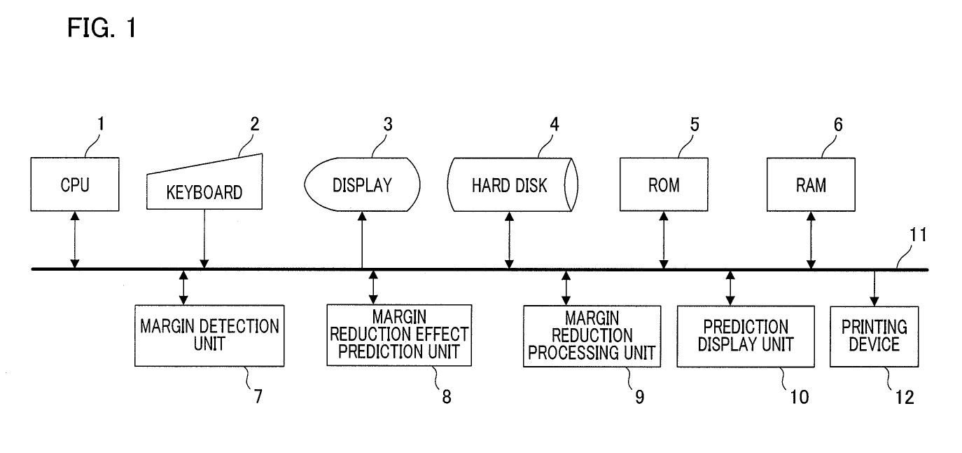

FIG. 1 shows an exemplary hardware configuration of a margin reduction print processing apparatus according to an embodiment of the present invention.

A CPU (Central Processing Unit) 1 that configures the control unit of a system interprets a program to execute predetermined processing. A keyboard 2 is an operation unit for data input, and a display 3 displays a document image or the like. A hard disk 4 for storing document files or the like, ROM (Read Only Memory) 5, and RAM (Random Access Memory) 6 are provided as data storage devices. The ROM 5 stores programs and necessary information for controlling a margin reduction print processing apparatus in advance, and the RAM 6 is employed as various working areas. A computer readable print processing program to be described below is stored in the ROM 5 in advance, or is provided by an external storage medium (not shown) or a network communication to thereby be loaded into the RAM 6.

A margin detection unit 7 detects margin portions between objects such as texts or drawings configuring document data. A margin reduction effect prediction unit 8 sums the distances of margin portions, and predicts the approximated number of printed papers upon margin reduction print processing from the summation result. A margin reduction processing unit 9 performs margin reduction processing for objects such as texts or drawings. A prediction display unit 10 displays the effect of margin reduction processing such as the number of printed papers to be used or the like. A part or all of the operations of these detection and processing units is controlled in accordance with a print processing program executed by the CPU 1. Also, although display information about the prediction display unit 10 is displayed on the display 3, FIG. 1 explicitly shows the units as functional blocks. A data bus 11 is used for various data transmission and connects the components with each other. A printing device 12 prints the result of margin reduction processing.

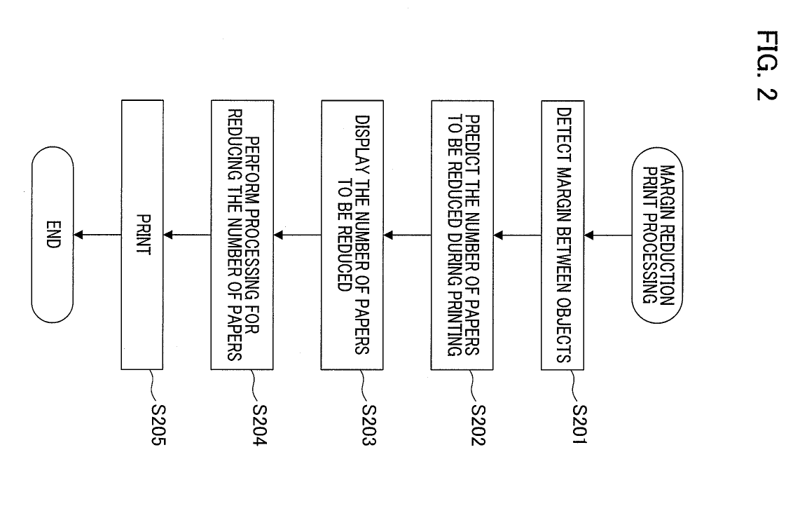

FIG. 2 is a flowchart illustrating an example of an overall flow of margin reduction print processing. Hereinafter, a description will be given of processing when the CPU 1 interprets and executes programs stored in the ROM 5. More specifically, the operation of the margin detection unit 7, the margin reduction effect prediction unit 8, the margin reduction processing unit 9, and the prediction display unit 10, all of which are shown in FIG. 1, will be described in detail with regard to margin reduction processing for the sent documents and print processing thereafter.

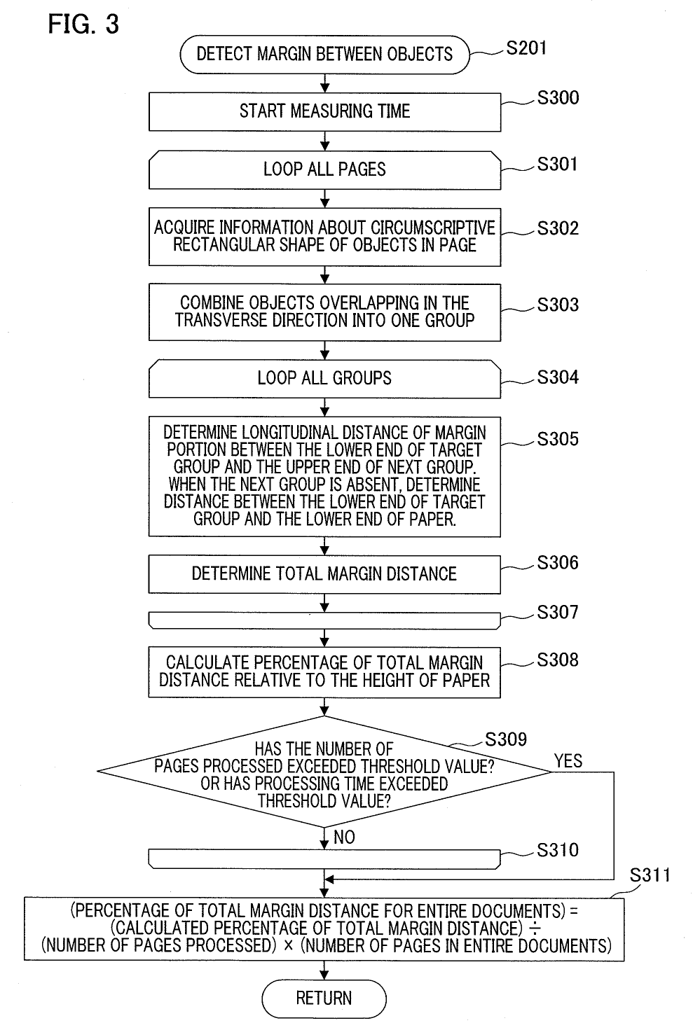

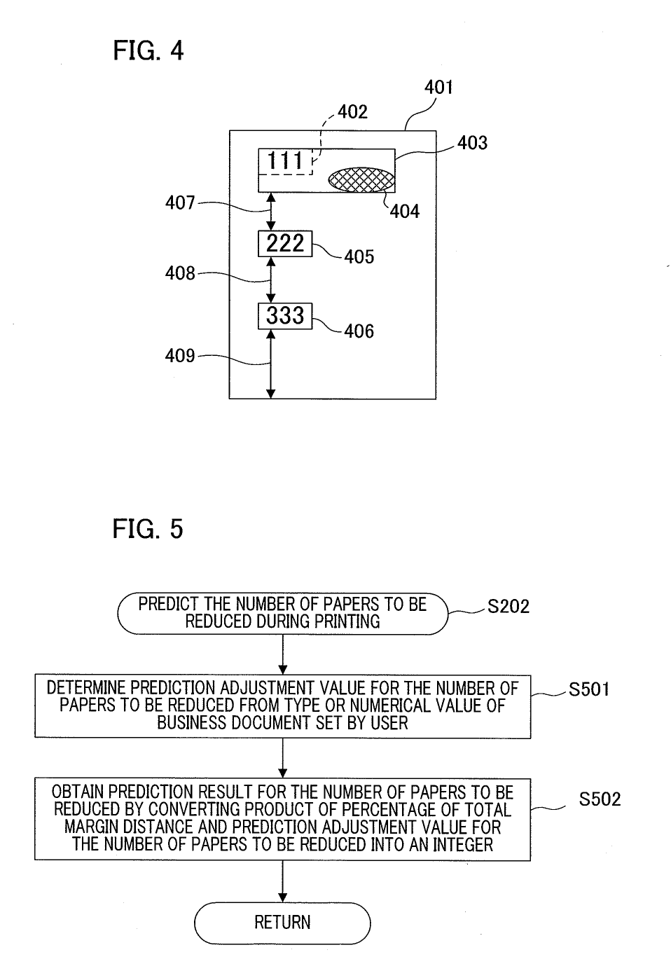

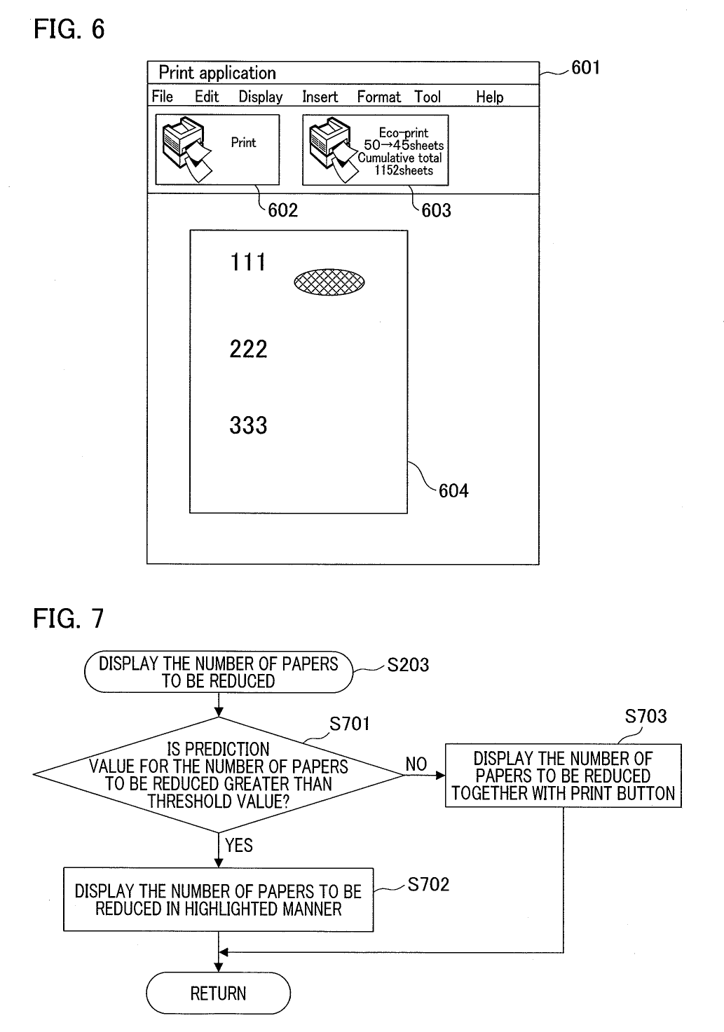

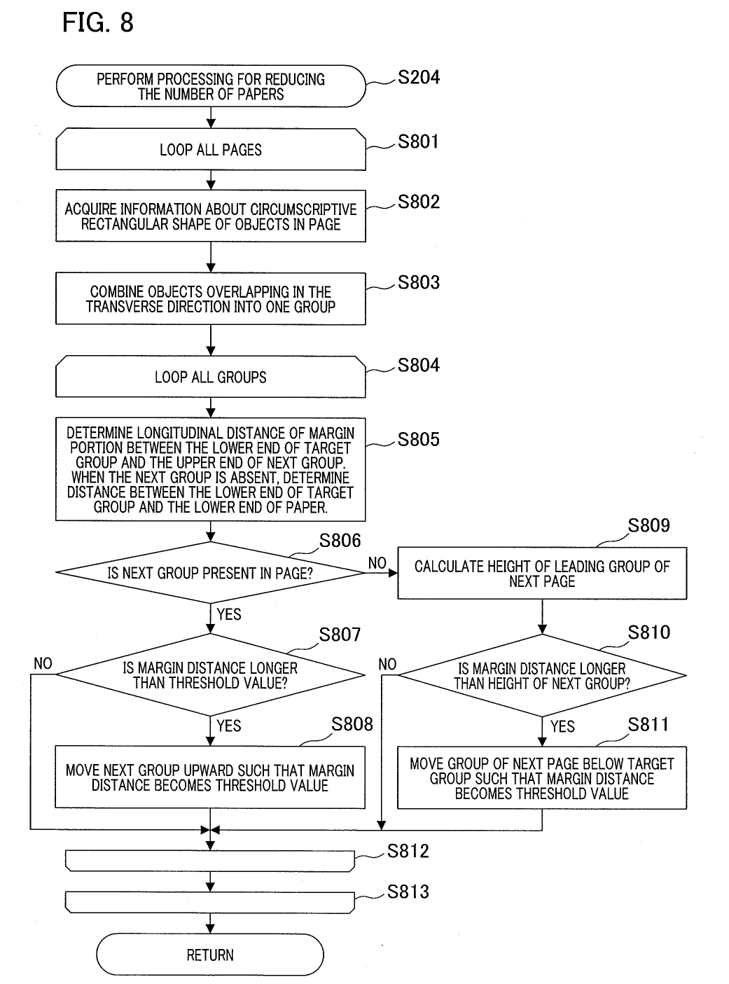

The flow of processing is as follows.
S201: the margin detection unit 7 performs margin detection for objects such as texts or drawings for each page in a document (to be described below with reference to FIGS. 3 and 4).
S202: the margin reduction effect prediction unit 8 predicts the number of papers to be reduced during printing (to be described below with reference to FIG. 5).
S203: the prediction display unit 10 performs display processing for the number of papers to be reduced during printing (to be described below with reference to FIGS. 6 and 7).
S204: the margin reduction processing unit 9 performs margin reduction print processing for reducing the number of papers (to be described below with reference to FIG. 8).
S205: the printing device 12 prints the margin reduction processing result.

### First Embodiment

Hereinafter, a specific description will be given of processing to be executed according to a first embodiment of the present invention.

FIG. 3 is a flowchart illustrating an example of processing (margin detection between objects) in step S201 shown in FIG. 2 performed by the margin detection unit 7. During margin detection processing, the margin distances between objects for each page are summed, the percentage of the summed margin distance relative to the length of a paper is calculated from the addition result, and then, the percentage of the total margin distance is finally calculated.

In step S300, the measurement of processing time is started. A time measuring operation is executed by a timer unit (not shown). Steps S301 to S310 are loop processes, and the processes in steps S302 to S309 sandwiched between step S301 and step S310 is repeatedly executed for pages.

In step S302, information about the circumscriptive rectangular shape of an object in a page is acquired. FIG. 4 shows an exemplary arrangement including a plurality of objects in a page. Text objects 402, 405, and 406 and a drawing object 404 are present in a page 401, and circumscriptive rectangular information about the objects is acquired. Note that circumscriptive rectangular information is information indicating a rectangular frame surrounding an object, and includes information such as the reference position (the left-hand corner position of a rectangular frame), the size (length or lateral width), or the like of the object.

In step S303, objects that overlap in the transverse direction are combined into one group. In the example shown in FIG. 4, the text object 402 and the drawing object 404 are arranged adjacently to each other in the transverse direction and overlap in the transverse direction, these two objects are identified as a first group 403. Since each of text objects 405 and 406 positioned below the first group 403 has no other object overlapping in the transverse direction, the text objects 405 and 406 independently configure one group (a second group 405, and a third group 406). While, in the present embodiment, a description will be given by taking an example of grouping processing step S303, margin detection between objects may directly be performed without grouping processing depending on specifications.

When grouping processing has been ended for all of the objects in the target page, the process advances to step S304. Steps S304 to S307 are loop processes, and the processes in steps S305 and S306 are executed for all of the groups.

In step S305, the longitudinal distance of a margin portion between the lower end of an object configuring a group and the upper end of another object configuring another group positioned below the group is specified. In the example shown in FIG. 4, a margin distance 407 between the first group 403 and the second group 405 positioned therebelow is calculated. Here, margin distance 407 is assumed to be 3 cm. Likewise, a margin distance 408 (assumed to be 5 cm) between the second group 405 and the third group 406 is calculated. As described above, the process for specifying the longitudinal distances of the margin portions between all of the groups in a page is executed. When the target group is a group at the lowermost position and there is no other group therebelow, the longitudinal distance between the lower end of an object configuring the target group and the lower end of a paper is calculated. Since there is no other group below the third group 406 shown in FIG. 4, the distance between the lower end of an object configuring the third group 406 and the lower end of a paper is determined as a margin distance 409 (assumed to be 8 cm).

Next, in step S306, the margin distances between groups, which have been specified in step S305, are added up to thereby calculate a total margin distance. As a result of addition of the margin distances 407 to 409, the total margin distance in the example shown in FIG. 4 becomes 3 cm+5 cm+8 cm=16 cm.

When it is determined in step S307 that processing for all of the groups has been ended, the process advances to step S308. On the other hand, when an unprocessed group remains, the process returns to step S305, and margin distance calculation processing is continued.

In step S308, the percentage of the total margin distance relative to the length of a paper is calculated. Assuming that the size of a paper shown in FIG. 4 is A4, the length of the paper is 29 cm. Thus, if the percentage of the total margin distance relative to the length of the paper is represented by a percentage, the percentage is represented by the formula: “16 cm÷29 cm×100≅55%”.

In step S309, the number of pages processed is compared with a threshold value for determination, or a processing time is compared with a threshold value for a determination time. If the number of pages processed exceeds a threshold value for determination or a processing time exceeds a threshold value for a determination time, the process advances to step S311. If not, the process advances to step S310 and processing continues. For example, if a large amount of processing is required when the total number of pages of documents is 1000 pages, a processing time for performing the processes in steps S302 to S308 consumes too much time, the time required to display the number of pages to be reduced in step S203 shown in FIG. 2 may take quite long. On the other hand, the document configuration does not change very much through the entire document. Specifically, the percentage of the total margin distance in the front half of the documents and the percentage of the total margin distance in the middle and the rear half of the documents hardly change. Hence, when the first 100 pages are set, for example, as a threshold value, the process may advance to step S311 upon calculation of the percentage of the total margin distance for 100 pages, and thus, the process becomes efficient. Note that a threshold value for determining the number of pages may be provided with a user interface such that a user may set it freely. In the present embodiment, the threshold value for determination is assumed to be 100 pages.

Also, in step S309, a processing time for determining a margin is compared with a threshold value for a determination time to define the upper limit of the processing time. In step S300, time measurement is started from the time of starting margin detection between objects. For example, when a threshold value for a determination time is set to 3 seconds, the process advances to step S311 at the point in time 3 or more seconds elapsed from the point in time that the percentage of the total margin distance of the first page has been calculated. For setting a threshold value for a determination time, a method for presenting a user to an input screen to prompt input of a threshold value or a method for describing “OBJECT_WHITE_DETECTION=3” or the like in a setting file to set a threshold value may be employed.

When the presence/absence of unprocessed pages has been determined in step S310 and there is no page to be processed, the process advances to step S311. When unprocessed pages are present, the process returns to step S301 and the process from step S302 continues.

In step S311, the percentage of the total margin distance for the entire document is calculated by the following formula:

(The percentage of the total margin distance for the entire document)=(The calculated percentage of the total margin distance)÷(The number of pages processed)×(the number of pages in the entire document) [Formula 1]

The percentage of the total margin distance relative to the number of pages processed is multiplied by the number of pages in the entire document. For example, when the number of pages in the entire document is 1000 pages and the percentage of the total margin distance for 100 pages is 400%, the following result is obtained.

(The ratio of the total margin distance for the entire document)=400%÷100 pages×1000 pages=4000%

Note that 100% is equal to the length of a paper, and represents a single paper. Thus, 4000% means that there is a margin for 40 pages of paper.

Next, a description will be given of step S202 (prediction processing for the number of papers to be reduced during printing) shown in FIG. 2 with reference to the flowchart shown in FIG. 5.

In step S501, a prediction adjustment value for the number of papers to be reduced is determined from the type or the numerical value of a business document set by a user. For example, it is assumed that the following items are displayed on a setting input screen presented to a user.
A document consisting mainly of characters (90%)
A document consisting mainly of drawings (70%)
A character and drawing document (80%)
Conference paper (95%)

A user may select a desired type of document from a plurality of the presented selections, or may input a desired numerical value and provide an instruction to a printing device about the number of papers to be reduced.

In step S502, reduction prediction information is calculated from the percentage of the total margin distance calculated in step S201 and the prediction adjustment value for the number of papers to be reduced obtained in step S501 using the following formula.

The prediction value for the number of papers to be reduced=INT (the percentage of the total margin distance×the prediction adjustment value for the number of papers to be reduced)

Note that INT( ) is a function that converts a formula value in parentheses into an integer, and thus, the prediction value for the number of papers to be reduced is calculated as an integer value. In the example explained in step S201, given that the percentage of the total margin distance is 4000% and the prediction adjustment value for the number of papers to be reduced is 70%, the prediction value for the number of papers to be reduced is obtained as follows:

4000% (corresponds to 40 pages)×70%=28 pages

Specifically, the prediction result in which 28 pages among the entire document (1000 pages) may be reduced is obtained. In the present embodiment, although the reason why the prediction adjustment value is 70% is because a margin may exist between objects during margin reduction print processing or the presence of a printable region is taken into consideration, any value may be set.

Next, a description will be given of step S203 (prediction display processing for the number of papers to be reduced) shown in FIG. 2. FIG. 6 shows an exemplary illustration of the number of printed papers to be reduced. In the present embodiment, a preview 604 for a document is rendered in a window 601, and a plurality of print buttons 602 and 603 is presented. The print button 602 is a normal print button without having a paper reduction setting, and a print button (hereinafter referred to as “eco-print button”) 603 for margin reduction print processing is arranged laterally thereto. When the number of pages in the entire document is 50 pages and a user operates the normal print button 602, the number of printed papers to be used needs to be 50. When a user operates the eco-print button 603, the indication that the number of printed papers to be used may be reduced from 50 to 45 is displayed. The cumulative total number of 1152 papers, which has been reduced in margin reduction processing printing up to this point, is also displayed on the eco-print button 603. With this arrangement, a user can recognize how many pages can be reduced by margin reduction print processing in advance and the cumulative total number of pages that have been reduced in margin reduction processing printing up to this point. Specifically, since a choice of selection either by operating the normal print button 602 for printout or by operating the eco-print button 603 for saving paper in spite of taking more time for processing to some extent is provided to a user, the user may readily select an operating button. Also, the effect of an increase in the user's willingness to reduce paper may be obtained by reporting the cumulative value for the number of papers to be reduced to the user.

FIG. 7 is a flowchart illustrating an example of prediction display processing for the number of papers to be reduced.

In step S701, the prediction value for the number of papers to be reduced is compared with a threshold value. When it is determined that the prediction value for the number of papers to be reduced is greater than a threshold value, the process advances to step S702. When it is determined that the prediction value for the number of papers to be reduced is equal to or less than a threshold value, the process advances to step S703. A threshold value is a value for determining the amount at which the number of predicted page reductions will be highlighted. For example, an input setting screen for selecting a threshold value or inputting a numerical value for a threshold value may be presented to a user. In the present embodiment, the threshold value is assumed to be 5%. In the example shown in FIG. 6, since the number of pages may be reduced from 50 to 45 (10% reduction effect), it is determined that the reduction effect is greater than the threshold value of 5%, and the process advances to step S702. In step S702, the display of the number of papers to be reduced is changed in a highlighted manner. For example, a method for displaying the expression “50→45 papers” on the eco-print button 603 in a specified color (red), a method for blinking the display, or a method for changing (reddening) the background color of the highlighted eco-print button 603 may be employed. Alternatively, the eco-print button 603, which is generally not displayed or is lightly displayed, may be darkly displayed. For highlight, any method may be employed as long as the eco-print button 603 is displayed in a manner more emphasized than normal display by changing any display attribute such as color, blinking, gradation, or the like.

In step S703, the number of papers to be reduced is subject to normal display together with the eco-print button 603. The term “normal display” refers to a normal display in black. Alternatively, when the paper reduction effect is small, the number of papers to be reduced may not be displayed. As described above, when it is predicted that the effect of margin reduction print processing is great, the paper reduction effect is reported to a user in a highlighted manner, and thus, an alert for eco-print processing may be provided to a user.

Next, a description will be given of step S204 (margin reduction print processing) shown in FIG. 2, that is, processing for reducing the number of papers. For margin reduction print processing for changing the arrangement of objects in a predetermined layout direction (in the present embodiment, the vertical direction), the method disclosed in Japanese Patent Laid-Open No. 2006-171979 is known. However, by the nature of the present invention, any type of margin reduction print processing may be performed. For example, processing for reducing a margin between groups as shown in FIG. 4 is also referred to as “margin reduction print processing”.

FIG. 8 is a flowchart illustrating an example of margin reduction print processing. The processes in steps S801 to S805 are the same as those in steps S301 to S305 shown in FIG. 3, and thus, no further description will be given here.

Steps S801 to S813 are loop processes, and processing in steps S802 to S812 is repeatedly executed for entire pages. Also, during loop processing in steps S804 to S812, processing in steps S805 to S811 is repeatedly executed for the entire groups.

In step S806, it is determined whether or not the next group is present in a page. When the next group is present, the process advances to step S807. When the next group is absent, the process advances to step S809.

In step S807, the margin distance is compared with a threshold value. When the longitudinal distance of the margin portion is greater than a threshold value, the process advances to step S808. When the distance is equal to or less than a threshold value, the process advances to step S812.

In step S808, the next group is moved upward for arrangement alteration such that the margin distance becomes a threshold value. In the example shown in FIG. 4, the threshold value is assumed to be 1 cm. The margin distance 407 between the first group 403 and the second group 405 is 3 cm, and thus, is longer than the threshold value of 1 cm. Thus, the second group 405 is moved upward by 2 cm such that the margin distance 407 becomes the threshold value of 1 cm. Movement processing is carried out for all of the groups positioned lower than the second group 405.

Next, a description will be given of a case where it has been determined in step S806 that the next group is absent in a page. In step S809, the length of the leading group of the next page (the position in the vertical direction of a page) is calculated. In step S810, it is determined whether or not the margin distance is longer than the length of the next group. When the margin distance is longer than the length of the next group, the process advances to step S811. If not, the process advances to step S812.

In step S811, the group of the next page is moved below the target group such that the margin distance becomes the threshold value. Other groups positioned below the moved group of the next page are uniformly moved upward by the amount of the moved group. Specifically, groups are shifted in the vertical direction across two pages in a state where two adjacent pages are virtually connected to each other.

In step S812, when it is determined that any unprocessed group remains, the process returns to step S804 and the process continues from step S805. When processing for all of the groups has been ended, the process advances to step S813. Here, when any unprocessed page remains, the process returns to step S801 and the process continues from step S802. When all of the pages have been processed, the process advances to step S205 shown in FIG. 2 and the printing device 12 prints the margin reduction processing result.

In the first embodiment, reduction prediction information about printed paper may be displayed prior to margin reduction print execution based on the result of summing the distances of the margin portions between objects in document data. Thus, according to the first embodiment, the effects shown in the following may be provided:
A user can employ the present function only when margin reduction print processing is valid.
A user can readily grasp printing paper reduction prediction information during editing.
A user can grasp whether or not papers may further be reduced by performing margin reduction print processing.

When a user does not want to save paper, a warning is not given each time during printing, and thus, the operational efficiency during printing is not decreased.

While, in the first embodiment, the margin distances between objects are detected, only the margin distance between an object positioned at the bottommost position of a page of a paper in the layout direction and the lower end of the paper may be determined in order to increase the processing speed.

### Second Embodiment

Next, a description will be given of a second embodiment of the present invention. Since the basic configuration of the second embodiment is the same as that of the first embodiment, a description will be given below only of the differences from the first embodiment. The same applies to a third embodiment to be described below, and thus, a description will be given only of the differences from the second embodiment.

In the second embodiment, a description will be given of the configuration in which the margin distance is properly detected when a footer is present in a page.

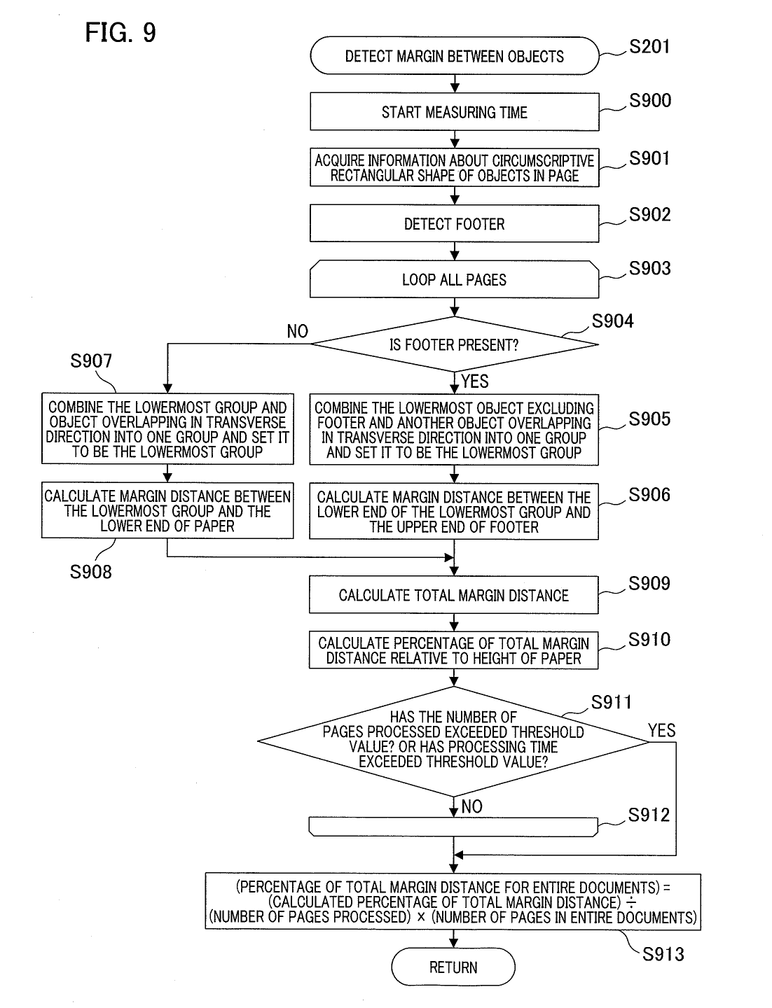

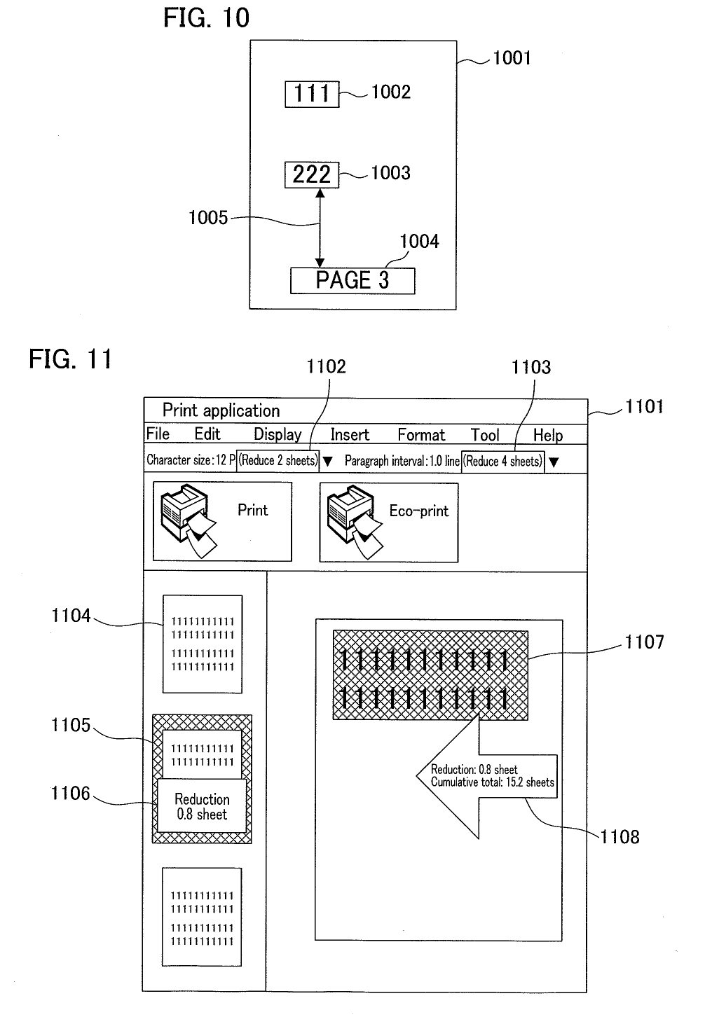

FIG. 9 is a flowchart illustrating high-speed processing performed by the margin detection unit 7 while taking a footer into consideration. FIG. 10 shows an exemplary arrangement of objects and a footer in a page.

The processes in step S900 and step S901 shown in FIG. 9 are the same as those in step S300 and step S302 shown in FIG. 3, respectively. A specific description will be given of circumscriptive rectangular information acquisition processing in step S901 with reference to the schematic diagram shown in FIG. 10. Circumscriptive rectangular information about text objects 1002, 1003, and 1004 in a Page 1001 is acquired. In the present embodiment, the object 1004 is a footer.

Next, in step S902, a footer is detected. A widely known ordinary method may be used as a footer detection method. For example, if an object is positioned at the bottom 10% or lower of a page and the object is also present at substantially the same position of other pages, it may be determined that the object is a footer. Processing in steps S903 to S912 is repeatedly executed for pages. When it has been determined in step S904 about the presence/absence of a footer and a footer is present, the process advances to step S905, whereas when a footer is absent, the process advances to step S907. In the example shown in FIG. 10, a footer 1004 is detected and the process advances to step S905. In step S905, the lowermost object excluding a footer and another object that overlaps in the transverse direction are combined into one group so as to be the lowermost group. Next, in step S906, the margin portion distance between the lower end of the lowermost group and the upper end of a footer is specified. In the example shown in FIG. 10, the lowermost object excluding the footer 1004 is the object 1003. Since the object has no other object overlapping in the transverse direction, the margin portion distance 1005 between the lowermost group 1003 and the footer 1004 is determined. Here, the margin portion distance 1005 is assumed to be 10 cm. Then, the process advances to step S909.

When it has been determined in step S904 that footer is absent, the process advances to step S907. The lowermost group and an object overlapping in the transverse direction are combined into one group so as to be the lowermost group. Next, in step S908, the margin portion distance between the lowermost group and the lower end of a paper is calculated, and the process advances to step S909.

In step S909, processing for calculating the total margin distance is performed. The margin distance between groups calculated in step S906 and step S908 are added up for pages to thereby determine the total margin distance. In step S910, the percentage of the total margin distance relative to the length of a paper is calculated, and the process advances to step S911. Here, it is determined whether or not the number of pages processed has exceeded a threshold value or whether or not the processing time has exceeded a threshold value. As in the first embodiment, if the first 100 pages out of 1000 pages of the entire document are set as a threshold value, the process advances to step S912 upon calculation of the percentage of the total margin distance for 100 pages. Also, when a threshold value for a processing time during which measurement is started in step S900 is assumed to be 3 seconds, the process advances to step S912 in time elapsed after 3 seconds or more after the percentage of the total margin distance of the first page has been calculated.

In step S912, it is determined whether or not any unprocessed page is present. If any unprocessed page is present, the process returns to step S903 and the process from step S904 continues. When no unprocessed page is present, the process advances to step S913. As in the first embodiment, the percentage of the total margin distance of the entire document is calculated using Formula 1, and then, margin detection processing between objects is ended. Then, prediction processing for the number of papers to be reduced during printing is performed. The subsequent processes are the same as those in the first embodiment.

In the second embodiment, the margin distance between the lowermost object and a footer in a page is calculated, and thus, processing may be performed at high speed. Furthermore, accurate margin distance detection while taking a footer into consideration may be realized.

### Third Embodiment

Next, a description will be given of a third embodiment.

In the third embodiment, when the margin reduction print processing prediction result is displayed on the print button of the prediction display unit 10, the following processing is performed:
Processing for conspicuously displaying a paragraph having a great margin reduction effect or a thumbnail of a printed page by changing the display attributes thereof.
Processing for displaying the allowable number of pages to be reduced upon changing line and paragraph intervals, character size, and margin setting together with respective sizes.
Processing for displaying margin reduction print processing functions and the allowable number of pages to be reduced as a virtual printer driver.

FIG. 11 is a schematic diagram illustrating an example of display processing. A drop box 1102 is displayed on a window 1101 for print application as print display for changing a character size in accordance with the user's operation instruction. In FIG. 11, when the character size is set to 12 point, the drop box 1102 denotes that a reduction by two papers is possible. Also, a drop box 1103 is provided for changing the settings of paragraph interval. When the paragraph interval is set to 1.0 line, the drop box 1103 denotes that a reduction by four papers is possible. A thumbnail 1104 displays the size-reduced content of a page. A background graphic pattern 1105 presents a page for which margin reduction print processing has a great effect, for example, a page of which the percentage of the margin portion is 50% or greater of the entire paper, to a user in a conspicuously displayed manner. For processing for calculating the predicted number of papers to be reduced, the processes in steps S300 to S311 shown in FIG. 3 are executed for each page.

A display unit 1106 for the predicted number of papers to be reduced presents the predicted number of papers to be reduced to a user for pages for which margin reduction print processing has a great effect. Also, on a preview column on the right of the thumbnail column, a paragraph for which margin reduction print processing has a great effect is presented to a user using a background graphic pattern 1107 in a conspicuously displayed manner. Beneath the background graphic pattern 1107, the predicted number of papers to be reduced and the cumulative total number of papers are displayed.

According to the third embodiment, the paper reduction effect of margin reduction print processing may readily be presented to a user in a more-detailed displayed manner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-009671 filed Jan. 20, 2011, which is hereby incorporated by reference herein in its entirety.

What is claimed is:

1. A print processing apparatus that performs print processing for reducing the number of printed papers to be used by changing the position of objects configuring document data in a predetermined layout direction, the print processing apparatus comprising:
a margin detection unit configured to specify a margin portion between the objects adjacent in the layout direction;
a prediction unit configured to calculate reduction prediction information when the print processing is performed based on the margin portion specified by the margin detection unit; and
a display unit configured to display the reduction prediction information calculated by the prediction unit prior to print execution.

2. The print processing apparatus according to claim 1, wherein the reduction prediction information is the number of by which printed papers are capable of being reduced.

3. The print processing apparatus according to claim 1, wherein the margin detection unit calculates the distance between an object that is at the bottommost position in the layout direction in a page and the lower end or the footer of a printing paper.

4. The print processing apparatus according to claim 1, wherein the margin detection unit calculates the distances of the margin portions over a preset number of pages, the prediction unit sums the distances of the margin portions calculated by the margin detection unit to thereby calculate the number of printing papers to be predicted for use upon the print processing from the summation result, and the display unit displays the number of printed papers calculated by the prediction unit.

5. The print processing apparatus according to claim 3, wherein the display unit displays the cumulative total number of printed papers reduced by the print processing.

6. The print processing apparatus according to claim 1, wherein, when the reduction prediction information calculated by the prediction unit exceeds a threshold value, the display unit changes a display attribute to thereby highlight the reduction prediction information.

7. The print processing apparatus according to claim 1, wherein, when the display unit displays an image of a printed page and the reduction prediction information for the printed page, which has been calculated by the prediction unit, exceeds a threshold value, the display unit changes the display attribute for the image and highlights the image.

8. The print processing apparatus according to claim 1, wherein the display unit displays the predicted number of printing papers to be reduced calculated by the prediction unit at a print display for use when a user makes an operation instruction or setting change for the print processing.

9. A control method to be executed by a print processing apparatus that performs print processing for reducing the number of printed papers to be used by changing the position of objects configuring document data in a predetermined layout direction, the control method comprising:
specifying, in a margin detection step, a margin portion between the objects adjacent in the layout direction;
calculating, in a prediction step, reduction prediction information when the print processing is performed based on the margin portion specified in the margin detection step; and
displaying, in a display step, the reduction prediction information calculated in the prediction step prior to print execution.

10. A storage medium storing a computer readable print processing program to be executed by a print processing apparatus that performs print processing for reducing the number of printed papers to be used by changing the position of objects configuring document data in a predetermined layout direction, the computer readable print processing program comprising:
specifying, in a margin detection step, a margin portion between the objects adjacent in the layout direction;
calculating, in a prediction step, reduction prediction information when the print processing is performed based on the margin portion specified in the margin detection step; and
displaying, in a display step, the reduction prediction information calculated in the prediction step prior to print execution.
